(19) United States
(12) Patent Application Publication
(10) Pub. No.: US 2023/0419404 A1
(43) Pub. Date: Dec. 28, 2023

(54) Methods and Systems for Determining Segmentation Rules for Categorising Entities

(71) Applicant: Xero Limited, Te Aro (NZ)

(72) Inventor: Donald Permezel, Te Aro (NZ)

(21) Appl. No.: 18/243,932

(22) Filed: Sep. 8, 2023

Related U.S. Application Data
(63) Continuation of application No. PCT/NZ2023/050015, filed on Mar. 24, 2023.

(30) Foreign Application Priority Data
Mar. 31, 2022 (AU) 2022900848

(51) Int. Cl. G06Q 40/03

(52) U.S. Cl. CPC G06Q 40/03

(57) ABSTRACT

Determining segment rule(s) for categorising entities according to financial risk comprise determining, for each entity, feature(s) indicative of financial risk, determining a survival rating for each entity based on determined entity attributes; and providing, as input to a segmentation rules determination module, the feature(s) and the survival rating for a subset of the entities of the second set of entities. They method may further comprise modifying, by the segmentation rules determination module, a set of segment rules until a completion condition is met and determining as output of the segmentation rules determination module, the segment rule(s).

### CROSS-REFERENCE TO RELATED APPLICATION(S)

This application is a continuation of International Application Serial No. PCT/NZ2023/050015, filed Mar. 24, 2023, which claims priority to and the benefit of Australian Patent Application Serial No. 2022900848, filed Mar. 31, 2022, the entire disclosures of which are hereby incorporated by reference.

### TECHNICAL FIELD

Described embodiments relate to computer-implemented methods and computing systems for determining segmentation rules for categorising entities. In some embodiments, the segment rules are configured to categorise entities according to determined financial risk. Some embodiments relate to computer-implemented methods and computing systems for categorising entities according to determined financial risk using the determined segmentation rules.

### BACKGROUND

Known computer-implemented techniques used by lenders for determining eligibility for financial assistance products (such as loans) tend to be inflexible, and take a “one size fits all” approach, resulting in candidate entities being broadly classified into approved and denied categories. Accordingly, many relatively low risk entities which may have benefited from financial assistance are not given access to them. Not only do these entities potentially fail due to lack of financial assistance, but lenders lose potential revenue from entities which may have actually been valuable clients.

It is desired to address or ameliorate some of the disadvantages associated with such prior methods and systems, or at least to provide a useful alternative thereto.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

Some embodiments relate to a computer implemented method comprising: A computer implemented method comprising: a) determining a first dataset of entities, each entity of the first dataset being associated with a set of attributes; b) determining a set of features for each of the entities based on the respective set of attributes, wherein each feature is indicative of financial risk; c) determining a survival rating for each of the entities of the first dataset of entities based on the respective set of attributes; d) determining a second set of entities from the first set of entities based on the predicted survival ratings of the entities; e) providing, as an input to a segmentation rules determination module, the set of features and the survival rating for each of the entities of the second set of entities; f) categorising, by a segmentation rules determination module, the entities of the second set of entities according to a set of segmentation rules; g) assessing a suitability of the set of segmentation rules based on the survival ratings of the entities in one or more categories; h) responsive to a completion condition not being met, modifying, by the segmentation rules determination module, the set of segment rules and performing steps f) to h); and i) responsive to the completion condition being met, determining as an output of the segmentation rules determination module, the set of segment rules for categorising entities according to financial risk.

In some embodiments, the method may comprise providing to a financial risk categorisation module, the determined set of segment rules, the financial risk categorisation module configured to use the determined set of segmentation rules to classify candidate entities according to financial risk. In some embodiment, the method may comprise providing a set of features of a candidate entity and a predicted survival rating of the candidate entity to the financial risk categorisation module; and classifying, by the financial risk categorisation module, the financial risk of the candidate entity.

Further embodiments may comprise: providing the sets of features and respective survival rating of each of the entities of the second dataset to the financial risk categorisation module; and classifying, by the financial risk categorisation module, the financial risk of the entities of the second dataset. In some embodiments, determining the first dataset of entities comprises: determining entities from a population of entities that comply with one or more eligibility factors.

In some embodiments, the set of segmentation rules comprises a first rule set configured to categorise a relatively highest risk category of entities and a second rule set configured to categorise a relatively lowest risk category of entities, and wherein categorising, by a segmentation rules determination module, the entities of the second set of entities according to the set of segmentation rules comprises applying the first rule set to the second set of entities to categorise a first portion of the second set of entities as associated with the relatively highest risk category, and subsequently applying the second rule set to the uncategorised entities of the second set of entities, to categorise a second portion of the second set of entities as associated with the relatively lowest risk category.

In some embodiments, the set of segmentation rules comprises a third rule set configured to categorise a relatively medium risk category of entities and wherein categorising, by a segmentation rules determination module, the entities of the second set of entities according to the set of segmentation rules comprising subsequent to applying the applying the second rule set to the uncategorised entities of the second set of entities, applying the third rule set to the uncategorised entities of the second set of entities, to categorise a third portion of the second set of entities as associated with the relatively medium risk category.

In some embodiments, determining the survival rating for each of the entities of the first dataset of entities based on the respective set of attributes comprises: determining whether an entity is active at the end of the observation period; responsive to determining that the entity is active at the end of the observation period, assigning the entity a first survival rating value; responsive to determining that the entity is inactive at the end of the observation period, determining whether the entity is active at the beginning of the observation period; responsive to determining that the entity is active at the beginning of the observation period, assigning the entity a second survival rating value; and responsive to determining that the entity is inactive at the beginning of the observation period, assigning the entity a third survival rating value; wherein the first, second and third survival rating values are different to one another.

In some embodiments determining the second dataset of entities from the first dataset of entities based on the determined survival ratings of the entities comprises: removing from the first set of entities, any entities that have a survival rating indicating they were low performing entities. In some embodiments the segmentation rules determination module comprises a genetic algorithm. In further embodiments the genetic algorithm is configured to optimise a set of initial segmentation rules according to a fitness function.

Some embodiments are directed to a system comprising: one or more processors; and memory comprising computer executable instructions, which when executed by the one or more processors, cause the system to perform any one of the methods described herein.

Some embodiments are directed to a computer-readable storage medium storing instructions that, when executed by a computer, cause the computer to perform any one of the methods described herein.

### BRIEF DESCRIPTION OF THE DRAWINGS

Some embodiments will now be described by way of non-limiting examples with reference to the accompanying drawings.

FIG. 1 is a process flow diagram of a high-level overview of a process for determining segmentation rules for categorising entities, and for categorising entities according to the determined segmentation rules, according to some embodiments;

FIG. 2 is a block diagram of a system for determining segment rules for categorising entities, according to some embodiments;

FIG. 3 is a process flow diagram for a method of determining segment rules for categorising entities, according to some embodiments;

FIG. 4 is a process flow diagram of a method of determining entity survival ratings for the method of FIG. 2, according to some embodiments;

FIG. 5 is a process flow diagram of a method of determining segmentation rules using a genetic algorithm, for the method of FIG. 2, according to some embodiments;

FIG. 6 is a process flow diagram of the method of assigning entities to segments according to the risk segment rules generated by the method of FIG. 2, according to some embodiments;

FIG. 7 is an example set of rules defining risk segments, according to some embodiments; and

FIG. 8 is an example of a message communication to an eligible entity offering risk priced loan services, according to some embodiments.

### DETAILED DESCRIPTION

Described embodiments relate to computer-implemented methods and computing systems for determining segmentation rules for categorising entities. In some embodiments, the segment rules are configured to categorise entities according to determined financial risk. Some embodiments relate to computer-implemented methods and computing systems for categorising entities according to determined financial risk using the determined segmentation rules.

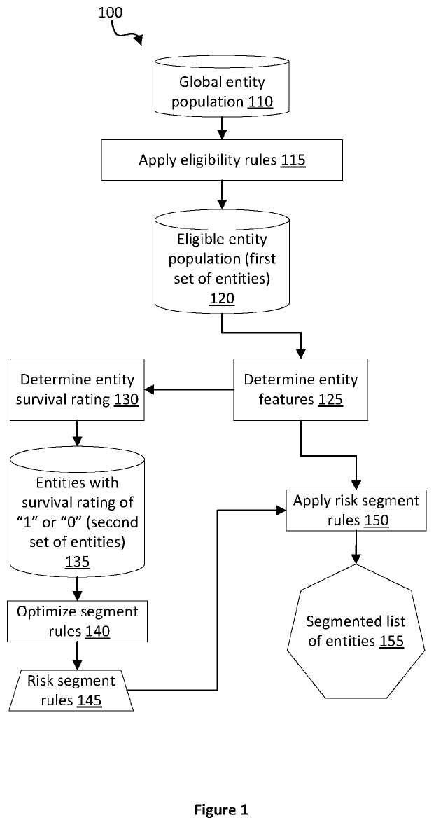

Referring to FIG. 1, a broad, high-level overview of the described embodiments is depicted. As shown in FIG. 1, segmentation rules determination system is configured to determine a global entity population (for example, from information maintained by an accounting platform and/or an accounting platform server system), at 110, and filter eligible entities to be used for determining segmentation rules for categorising entities from ineligible entities based on eligibility criteria or rules, at 115. This results in a first set of entities, at 120.

The segmentation rules determination system collects and analyses entity attribute data associated with the first set of entities. The entity attribute data may be collated over specific periods, and analysed to determine entity attributes that describe or are indicative of an entities' financial performance and/or behaviour. An entity risk features module of the segmentation rules determination system may be configured to determine entity risk features, and/or rules and values that may be indicative of an expected success or failure of an entity in the future, based on the entity attributes, at 125. Success or failure of an entity may relate to an entity continuing or ceasing operation, respectively.

In some embodiments, an entity survival rating module of the segmentation rules determination system is configured to determine predicted entity survival ratings for each entity based on the associated entity risk features for the entity, at 130. The entity survival rating module may be configured to determine a second set of entities, which may be a subset of the first set of entities, by filtering the first set of entities by entity survival rating, at 135. The entity survival rating module may be configured to allocate each entity of the first set of entities an entity survival rating indicative of the health of the business, and which may, for example, be based on one or more entity attributes of features. For example, each entity of the first set may be allocated an entity health or survival rating of “1”, “0”, or “4”, with “0” being representative of the entity that is relatively high performing as of the end of a specific period, for example, being in business at the end of a specific period, “1” being representative of the entity performing relatively moderately well as of the end of the specific period, for example, being in business at the start of the specific period but out of business by the end of the specific period, and “−1” being representative of the entity performing poorly over the entire specific period, for example, being out of business at the start of the specific period. The entity survival rating module may be configured to filter out or eliminate all entities having a predicted survival rating of “−1” such that the second set of entities includes only entities having a predicted survival rating of “0” or “1”.

The segmentation rules determination system may determine numerical representations, such as binary strings, of the entity risk features and entity survival rating for each entity of the second set of entities and provides them as inputs to a segmentation rules determination module, at 140, to generate segmentation rules for categorising entities, at 145. The segmentation rules determination module may use a genetic algorithm to generate the segmentation rules. Once the segmentation rules for categorising entities have been determined, a financial risk categorisation module of the segmentation rules determination system or other computing system may use them to categorise or classify entities according to financial risk at 150. This may result in a segmented list of entities, at 155.

The segmentation rules determination module may use informed irrevocable search control strategies to determine the segmentation rules for categorising entities. Specifically, the segmentation rules determination module may comprise one or more genetic algorithms to create and optimise risk segmentation rules. The genetic algorithm may rely on a process of chromosome initialisation, fitness function calculation, chromosome crossover, genetic mutation, survivor selection and iteration of these steps to create and optimise the risk segment rules. In some embodiments, a chromosome may represent all risk segment rules defining all risk segments. In other embodiments, a chromosome may represent the rules for a single risk segment, or a single rule.

By selecting particular entity risk features and in some embodiments, particular combinations of entity risk features, as inputs for the segmentation rules determination module, improved segmentation rules may be determined, thereby allowing for improved classification of entities in terms of financial risk.

The entity survival rating module provides for the dual advantages of eliminating from the segmentation process, entities that are inappropriate, for example, unacceptably high risk, and should not be used for generating segment rules, but also determining a health or survival rating for use as an input to the segmentation rules determination module. By including the value for the predicted survival rating, in additional to the entity risk features, the generated segmentation rules tend to be better at appropriately classifying entities according to risk. For example, in some embodiments, a fitness function used to optimise the segmentation rules may determine a fitness score based on the survival ratings.

The described methods and systems for determining segmentation rules for categorising entities provide significant advantages over known prior art systems and methods. In particular, the described embodiments allow for the creation and optimisation of rules that can be used to classify entities based on myriad attributes and features derived from these attributes. Using a combination of attributes, described embodiments may account for various behavioural metrics associated with a set of entities to comprehensively describe the behaviours of these entities and possible outcomes stemming from these behaviours. The described multivariate methods enable the capture of relevant data that in known prior art methods has previously been neglected, and therefore, embodiments may result in risk segment rules that are more comprehensive and more sensitive to important entity details.

The creation of comprehensive and sensitive rules for the segmentation of entities allows for related methods that may take advantage of the significant increase in sensitivity. Computer-implemented methods or systems of classification that previously relied on simple metrics, or binary pass/fail designations may instead now utilise a spectrum or gradient to classify and therefore engage with the classified entities. For example, entities that were previously either permitted or barred from the receipt of services or goods may now be allowed access on the basis of their attributes, behaviours and/or outcomes. Accordingly, the described embodiments may result in highly personalised segmentation rules for the inclusion of entities and observance of attributes that are unique to an entity and would materially affect their needs.

One such example of the benefits of the increased sensitivity of the segmentation rules afforded by the described embodiments is the provision of financial assistance products (or loans). Prior art automated techniques for approving entities for the receipt of financial assistance products have used a binary included/excluded technique where entities are required to meet specific thresholds for a set of financial queries, and unless all of those thresholds are met, the entities are not approved for financial assistance products. Accordingly, entities that may have benefitted from financial assistance products may not be classified as eligible, and this may result in entity failure. Embodiments may allow financial assistance product providers to instead classify known entities in a series of segments based on one or more entity attributes and price products accordingly.

The described methods for determining segmentation rules for categorising entities may be tailored to entity attributes pertaining to specific goods or service providers or industries. The described systems and methods may be tailored by altering the number and/or type of entity attributes collected and analysed, the number and/or type of entities the data is collected from, the way the entity features are determined, performance metrics, the number of segments desired or any other variable attribute of the described embodiments. These attributes may be altered by a service provider looking to offer services based on segmentation, by a software as a service provider providing segment creation as a service, or by a user seeking to determine segmentation rules.

The described methods and systems for determining risk segment rules may be integrated into an online web client to allow for users to determine segment rules based on their own data inputs. The described embodiments may be configured to communicate with a bulk messaging system, such as an email client, to communicate with entities that may have been included in the segment rule creation process.

Throughout the specification the term “entity” or variations such as “entities” may refer to businesses, corporations, sole traders, franchises, contractors and/or any other person or thing that may engage in financial transactions.

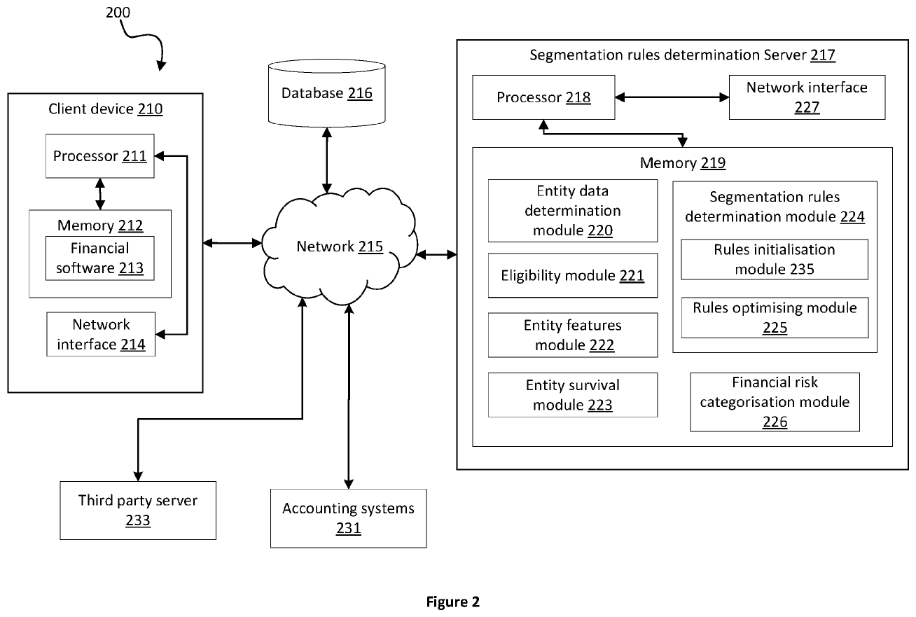

Referring now to FIG. 2, there is shown a block diagram of system 200 for determining segmentation rules for categorising entities, according to some embodiments.

As illustrated, the system 200 comprises a segmentation rules determination server 217, arranged to communicate with one or more databases 216 over a network 215. In some embodiments, the segmentation rules determination server 217 is further configured to communicate with an accounting system 231 and/or one or more databases 216 over the network 215. For example, the segmentation rules determination server 217 may be configured to receive entity information from the accounting system 231 and/or database(s) 216.

Segmentation rules determination server 217 may be configured to generate and/or determine segmentation rules for classifying or categorising entities according to specific factor(s), such as financial risk. In some embodiments, segmentation rules determination server 217 may comprise a financial risk categorisation module 226 which applies the segmentation rules to classify entities. In other embodiments, the application of the segment rules to classify entities into segments may be performed at a different or third party server 233 or client device 210. For example, a third party server 233, such as a server of a financial institution or bank, may comprise the financial risk categorisation module 226 which uses the generated segment rules to categorise entities according to financial risk. As illustrated the third party server 233 and/or client device(s) 210 may be configured to communicate with each other, the segmentation rules determination server 217, the one or more databases 216, the accounting system 231, and/or the one or more client devices 210 over the network 215.

The accounting system 231 may comprise one or more computing devices and/or server devices, such as one or more servers, databases, and/or processing devices in communication over a network. The accounting system 231 may be configured to provide accounting services to users, such as entities and accounts, and to maintain accounts for a plurality of entities, such as businesses, individuals and organisations. For example, the accounting system 231 may be used by an accounting services provider such as an accountant, and used to track payer data and invoice data generated with respect to clients of the accounting services provider, such as business entities.

According to some embodiments, the accounting system 231 may comprise a cloud based server system. The accounting system 231 may further comprise a processor (not shown) in communication with a memory (not shown). The processor (not shown) may comprise one or more data processors for executing instructions, and may comprise one or more microprocessor based platforms, central processing units (CPUs), application specific instruction set processors (ASIPs), application specific integrated circuits (ASICs), suitable integrated circuits, or other processors capable of fetching and executing instruction code as stored in the memory. The processor (not shown) may include an arithmetic logic unit (ALU) for mathematical and/or logical execution of instructions, such as operations performed on the data stored in internal registers of the processor.

The accounting system 231 may be configured to receive and/or store data related to one or more invoices issued by an entity to a client or customer. Invoice data may include a unique invoice identifier, such as an invoice number. Invoice data may also include one or more of a payment date, payment deadline, payment amount, discount amount, tax amount and unique client or invoice identifier. The unique client identifier may include one or more of the client name, client contact information such as a telephone number, a company registration number (such as an ABN or ACN) or a number generated by the accounting system 231 to uniquely identify the client.

The accounting system 231 may also be configured to store data relating to payers associated with the business entity, such as clients and customers to whom invoices are issued. Payer data may include one or more of the payer name, payer contact information such as a telephone number, a company registration number (such as an ABN or ACN) or a payer identifier such as a payer account number.

The accounting system 231 may be configured to execute functions such as reading and writing invoice and/or payer data and communicating retrieved data to segmentation rules determination server 217. This data may be communicated between the accounting system 231 and the segmentation rule determination server 217 via network 215, wired connection (not shown) and/or may be comprised within the same computer system or server (not shown).

The accounting system 231 may communicate with one or more financial institute or banking servers, such as server 233. In some embodiments, the accounting system 231 receives, from such server(s) 233, records or documents associated with data being monitored by the accounting system 231. For example, the accounting system 231 may be arranged to receive bank feeds associated with transactions to be reconciled by the accounting system 231. The financial or banking data may be imported through a bank feed and/or a user- or accountant-created document. In some embodiments, the accounting system 231 may communicate with third-party tools of the server(s) 233 via an application protocol interface (API) to receive the banking data.

In a further embodiment, segmentation rules determination server 217 may also be a sub-system of, or comprise a banking computer system (not pictured). The banking computer system may comprise one or more computing devices and/or server devices, such as one or more servers, databases, and/or processing devices in communication over a network, or comprised within a system. The bank computer system may be operated by a bank or financial services provider, and used to store data relating to a financial account of an entity and transactions to and from that account.

The banking computer system may be configured to store transaction data related to transactions made to and from a bank account associated with the entity, and specifically may relate to one or more deposits made to the bank account. Account transaction data may include a description narrative. The description narrative may be entered by the payer at the time of payment, or generated by the payment platform used by the payer to make the payment. According to some embodiments, account transaction data may further include one or more of a payment date, payment amount, and a payer identifier. The payer identifier may include one or more of the payer name, payer contact information such as a telephone number, a company registration number (such as an ABN or ACN) or a number generated by the bank to uniquely identify the payer, such as a payer account number.

In some embodiments, segmentation rules determination server 217, accounting computer system and banking computer system may be sub-systems of a financial services provider computer system (not pictured). The financial services provider's computer system may be configured to maintain accounts for a plurality of entities and provide accounting service to those entities. The segmentation rules determination server 217 may have access to entity attributes and/or servers storing financial and/or banking data relating to entities by virtue of being a sub-system of the financial services provider computer system.

The network 215 may include, for example, at least a portion of one or more networks having one or more nodes that transmit, receive, forward, generate, buffer, store, route, switch, process, or a combination thereof, etc. one or more messages, packets, signals, some combination thereof, or so forth. The network 215 may include, for example, one or more of: a wireless network, a wired network, an internet, an intranet, a public network, a packet-switched network, a circuit-switched network, an ad hoc network, an infrastructure network, a public-switched telephone network (PSTN), a cable network, a cellular network, a satellite network, a fibre-optic network, some combination thereof, or so forth.

In some embodiments, the client device 210 may comprise a mobile or handheld computing device such as a smartphone or tablet, a laptop, or a PC, and may, in some embodiments, comprise multiple computing devices. The client device 210 may comprise financial software 213 or a financial software suite configured to record financial data entered by the client for processing by the system 200. In some embodiments the financial software 213 may be configured to communicate with other software contained in the memory 212 of the client device 210 to receive financial data.

Database 216 may be a relational database for storing information generated, extracted or obtained from client device 210 or by the risk calculating server 217. In some embodiments, the database 216 may be a non-relational database or NoSQL database. Database 216 may form part of or be local to the segmentation rules determination server 217, or may be remote from and accessible to the segmentation rules determination server 217. The database 216 may be configured to store data and records associated with entities having user accounts with the accounting system 231, availing of the services and functionality of the accounting system 231, or otherwise being associated with accounting system 231. For example, the data and/or records may comprise business records, banking records, accounting documents and/or accounting records.

The segmentation rules determination server 217 comprises one or more processors 218 and memory 219 accessible to the processor 218. Memory 219 may comprise computer executable instructions (code) or modules, which, when executed by the one or more processors 218, is configured to cause the segmentation rules determination server 217 to perform operations as described herein, including to generate and/or determine segment rules for classifying or categorising entities according to specific factor(s), such as financial risk. For example, the segmentation rules determination server 217 may be configured to determine entity data, assess eligibility of entities for inclusion in the process, determine entity features, determine entity survival ratings, and/or initialise and/or optimise segment rules. In some embodiments, the segmentation rules determination server 217 is also configured to assign entities to a risk segment using the optimised segmentation rules. Accordingly, memory 219 of the segmentation rules determination server 217 may comprise an entity data determination module 220, an eligibility module 221, an entity features module 222, an entity survival ratings module 223, and/or a segmentation rules determination module 224, and in some embodiments, a financial risk categorisation module 226. The segmentation rules determination module 224 may comprise a rules initialisation module 235 and a rule optimising module 225.

In some embodiments, the entity data determination module 220 comprises program code, which when executed by one or more processors 218, is configured to determine a first dataset of entities with each entity of the first dataset being associated with a set of attributes. The first dataset of entities and entity data associated with the entities of the first dataset may be received, collected and/or retrieved from the database(s) 216, client device(s) 210, third party server(s) 233, accounting system 231 and/or any other suitable source. In some embodiments, the entity data may be financial data. For example, entity data may comprise invoices created and/or issued, statements, statement line items, contact information, organisation information, total dollar amount of paid invoices over a specific period, average days it takes for an invoice to be paid, taxes paid over a specific period, total discounts offered on invoices over a specific period and/or any other type of data that relates to a entities' financial dealings, behaviours or interactions. A specific period may be 24 months, 12 months, 6 months, 3 months, 1 month, 2 weeks, 1 week, or any other increment of time that an entities' attributes may be tracked over.

In some embodiments, the entity financial data may be used by eligibility module 221 to determine if an entity of the first dataset is eligible for use in determining the segment rules. The eligibility module 221 may determine if entity data for a particular entity complies with relevant lending laws for financial services in a given jurisdiction. For example, an entity may be eligible for financial services based on their tax payment status or location, as may be determined from the entity data.

The entity data determination module 220 performs data collection and curation on the financial data entered by the user at client device 210 using financial software 213 and stored in database 216. In some embodiments the entity data collection module 220 may be configured to periodically collect snapshots of financial data over specific periods of time. In alternative embodiments, data collection may be accomplished by manual data entry, and/or manual calculation.

In another embodiment, segmentation rules determination server 217 may be a sub-system of, or comprise an accounting computer system (not pictured). The segmentation rules determination server 217 may have access to entity attributes via the accounting computer system.

The eligibility module 221 is configured to perform an assessment of each of the plurality of entities' eligibility for use in determining the segmentation rules based on the entity's respective entity data. For example, the eligibility module 221 may be configured to determine whether the entities of the first dataset are eligible to receive financial assistance products according to eligibility criteria or rules. This may include reviewing tax payment status, entity location and/or annual net or gross income. In some embodiments, an entities' eligibility may be based on relevant laws and/or regulations of the country and/or region the entity and/or financial assistance product provider are located in and/or certified to operate. If an entity is deemed ineligible it will be removed from the data population (i.e. the first dataset) and their entity attributes will have no impact on future calculations.

The entity features module 222 is configured to determine a set of entity features for each of the entities of the first dataset based on entity attributes or characteristics derived from the respective entity data determined by the entity data determination module 220. In some embodiments entity attributes or characteristics may be classified into categories such as standard attributes, organisation attributes, behavioural attributes, accounting attributes, financial attributes, cash flow attributes and/or any other category of attributes that may broadly describe characteristics attributable to or indicative of an entity and/or its behaviours.

Standard attributes may comprise entity location, entity maturity, annual net and/or gross income and/or types of goods/services provided and the types of entities the goods/services are provided to.

Organisation attributes may comprise company size, number of employees, location, operational jurisdictions, number of customers, number of suppliers, organisation type, etc.

Behavioural attributes may comprise characteristics derived from an entities' behaviour when engaging in business rather than their quantitative financial performance. Behavioural attributes may comprise rate of successful invoice collection, tax paying behaviours, late fees, credit dishonours, invoice discounting rates and amounts or any other type of measurable behaviour that may be associated with an entity.

Accounting attributes may comprise types of accounts held by an entity, raw account values, changes in raw account values, rates of change in raw account values or any other quantitative account data that may be associated with an entity.

Financial or banking attributes may comprise details associated with or retrieve, directly or indirectly, from the bank of an entity, and may, for example, include current account balance, saving account balance, regularity and/or types of payments or deposits etc.

Cash flow attributes may be features that relate directly to an entities' cash flow such as number of debits, number of credits, average credit amount, average debit amount, variance in rates of credits, variance in rates of debits or any other values that are related to or derived from cash flow that may be associated with an entity.

The entity features module 222 may define one or more features of a set of entity features as values or raw values of entity attributes associated with the entity. For example, an entity attribute and respective entity feature may be any of: total tax paid, total funds on hand at a given time, number of invoices paid.

In some embodiments, multiple entity attribute values may be required to define an entity feature. For example, the entity features module 222 may be configured to determine a rate of change of an entity attribute over time. For example, the entity features module 222 may be configured to determine a first snapshot of entity data of an entity as a first point in time, and to determine a second snapshot of entity data of the first entity at a later point in time, to compare the first and second snapshots to determine or calculate a difference or rate of change of one or more of the entity attributes associated with the first entity. For example, such a rate of change may be an increase or decrease in monthly income, number of invoices raised, discounts on unpaid invoices, asset fluctuations or any other value that may be calculated over a specific period or series of specific periods. Accordingly, in some embodiments, one or more of the entity features determined by the entity features module 222 may correspond with rates of change of entity attributes.

In some embodiments, the entity features module 222 may be configured to determine and/or calculate entity features that are indicative of whether entities exhibit preferable characteristics. In some embodiments, preferable characteristics may be those indicative of entities that have good character, such as issuing timely invoices and receiving payment of those invoices consistently and reliably. This may be determined by determining a number of invoices raised by the entity in the 24 months prior to the end of the specific period and determining how many of those invoices are paid within 90 days of issue. Determining if invoices are reliably paid may comprise monitoring invoices and/or tracking changes made to an invoice with respect to amount and due date to determine whether the invoice was paid in full as it was initially issued, or whether there accommodations made to the invoice such as changed due dates and/or discounted charges.

Another preferable characteristic of an entity may be its level of activity, health and/or aliveness. Activity, health and/or aliveness may be determined by tracking the number of credits in a financial account associated with the entity over a time span of the specific period. The size of an entity may also be a preferable characteristic, and this may be determined by tracking an entity's revenue over a 12 month period, with higher revenue being preferable. Further preferable characteristics may be large entities that properly pay relevant taxes and that keep an accurate balance sheet. These may be determined by tracking the total taxes paid over a 12 month period and collecting total current asset value, respectively.

The entity survival rating module 223 may comprise code to determine and/or calculate entity survival ratings based on the associated entity attributes and/or risk features for the entity. The entity survival rating module 223 may be configured to filter out entities considered as unsuitable or extremely high risk, and which should not be relied on to generate the segmentations rules. The survival rating may be indicative of a likelihood of an entity continuing to perform well over a given period of time, for example, continuing to exist or be in business for a given period of time. For example, each entity may be allocated an entity survival rating of “1”, “0”, and “4”, with “0” being representative of the entity being considered as relatively low risk, and, for example in business at the end of a specific period (i.e. not out of business), “1” being representative of the entity being considered as relatively medium risk, and for example in business at the start of the specific period but out of business by the end of the specific period, and “−1” being representative of the entity being considered as relatively high risk and for example, out of business at the start of the specific period. The entity survival rating module 223 may be configured to filter out or eliminate all entities having a predicted survival rating of “−1” such that only entities having a predicted survival rating of “0” or “1” (i.e. relatively low or medium risk) are used for generating the segmentation rules.

In some embodiments, the entity survival ratings may be based on a measure of medium term business continuity (MTBC), medium term invoice collection (MTIC) and/or short term invoice collection (STIC).

The entity survival module 223 may comprise code to determine and/or calculate entity survival ratings based on one or more status variables assigned to the entity based on the entities compliance with certain survival criteria. The entities' status variables may be set to a default value before applying the survival criteria. The relevant status variable of each entity may then be changed to another value upon a criterion being determined as true or false based on the entity's features or attributes. Once all survival criteria have been applied, the entity's survival rating is determined based on the associated status variable(s). In some embodiments, the rates of each calculated survival rating may be compared to control data taken from real world entities to determine a measure or reliability of the entity survival calculation process.

The segmentation rules determination module 224 receives as inputs the survival rating and entity features associated with each of the candidate entities and performs the creation and/or determination and optimisation of the segmentation rules based on that information. For example, the entities are categorised by applying an initial set of rules to the entity features, and a fitness function is used to determine the suitability or effectiveness of the categorisation. The survival rating of each entity is used as a metric or variable for the fitness function. Responsive to a fitness value falling short of a threshold, the segmentation rules determination module 224 is configured to modify the initial set of rules and re-categorise the entities according to the new set of rules. This process may repeated until the threshold has been achieved, or a number of iterations have been performed, for example, and as will be explained in more detail below.

The segmentation rules determination module 224 determines the initial set of segmentation rules that will undergo optimisation. In some embodiments, initial set of segmentation rules are generated randomly. In other embodiments, the initial set of segmentation rules may be taken from a previously determined set of rules, or experimentally determined. In some embodiments, the initial set of segmentation rules may be set by an operator, or received as an input to the segmentation rules determination module 224.

The segmentation rules may be a rule or set of rules in the form [entity feature]+[equality operator]+[value/percentage/Boolean]. A rule or series of rules may also be followed by a conditional operator such as AND or OR that connects the rule or rules to another rule or rules. A risk segment may be defined by a set of rules connected by conditional operators, which differentiates it from other segments. Segments may have rules that relate to the same entity feature, but have different equality operators and/or require different values/percentages/Boolean value when compared to the same entity feature when used in another rule or rules of another set or sets of segment rules.

The segmentation rules determination module 224 may comprise program code configured to optimise and improve the initial risk segment rules. In some embodiments, the performance of a segment rule or series of segment rules defining a segment may be determined based on entity features, survival ratings and a criteria or fitness function for the performance of the rule or series of rules (e.g. a defined performance metric). If the rule or series of rules does not meet a defined performance metric, the segmentation rules determination module 224 may alter the rule or rules to attempt to improve it. The improvement process may be performed iteratively until a performance metric is reached relating to all rules or a series of rules defining the risk segments, at which time the segmentation rules determination module 224 terminates the optimisation process and returns or outputs the final set of segmentation rules.

The segmentation rules determination module 224 may comprise computer code configured to execute an informed irrevocable search strategy on the initial set of segmentation rules population. In some embodiments, segmentation rules determination module 224 may comprise a genetic algorithm for the iterative optimisation of the risk segment rules. The genetic algorithm accepts as inputs a survival rating and a set of entity features for each of the candidate entities.

The segmentation determination module 224 may determine an initial chromosome population comprising a plurality of chromosomes. A chromosome may comprise a plurality of genes. A gene may constitute a finite portion of a chromosome, such that a chromosome may be split into its constituent genes, or groups of two or more constituent genes.

Each gene may comprise a series of segmentation rules defining an entire segment, a single segmentation rule, or a single element of a logic statement such as an entity feature, a comparison operator, a value/percentage/Boolean or a logical operator such as AND or OR. Accordingly, each chromosome may comprise a set of rules to define all segments, a set of rules to define a single segment, a single segment rule, or a single element of a segment rule.

In some embodiments, the segmentation determination module 224 may comprise a fitness function which may define a desired requirement of the performance of the segmentation rules. This desired requirement may be a desired number of entities classified into each segment or into one specific segment, for example.

In some embodiments, the desired requirement or fitness threshold to be met may be an acceptable level of risk over one or more risk segments. For example, the risk level may be based on the number of entities with a survival rating of “0” compared to the number of entities with a survival rating of “1” in one or more segments. A segment may be assessed by the fitness function as meeting the desired performance requirement if the ratio/percentage of entities with a survival rating of “1” when compared to the number of entities with a survival rating of “0” is 4% or less, for example.

In some embodiments, the fitness threshold may be a desired percentage of entities in one or more of the segments, and a desired level of risk in one or more of the segments. The desired level of risk may be based on or determined as a ratio of entities with a survival rating of “1” (relatively medium risk rating) relative to entities with a survival rating of “0” (relatively low risk level).

Initially, the segmentation rules determination module 224 may perform a fitness function assessment to rate the initial chromosome population, as applied to categorise the entities of the second dataset, using as a metric the survival rating for each entity of the second dataset. In some embodiments, the fitness value given or determined by the fitness function may be a ratio/percentage representing a number of entities with relatively low risk rating captured within a segment. Dependent on this fitness score, the segmentation rules determination module 224 may perform a splitting process on a first high performing chromosome into a first collection of two or more gene subsets. The segmentation rules determination module 224 may then perform a cross over process on the first collection of two or more gene subsets with a second collection of two or more gene subsets from a second high performing chromosome to create a one or more new chromosome. The cross over process may comprise combining a first gene subset from a first parent chromosome with a second gene subset from a second parent chromosome. Segmentation rules determination module 224 may perform the fitness function assessment, splitting process and cross over process for all chromosomes in the initial chromosome population to determine a new chromosome population.

The segmentation rules determination module 224 may perform a mutation process on the new chromosome population by randomly altering one or more gene of each chromosome of the new chromosome population. The mutation process performed by segmentation rules determination module 224 may be completely random, or it can be guided by the program code of the segmentation rules determination module 224. The segmentation rules determination module 224 may then repeat the fitness function assessment, splitting process, cross over process and mutation process until a completion condition is met. In some embodiments the completion condition may be a total number of iterations. In other embodiments, the completion condition may be considered met when an overall fitness score of the one or more chromosome reaches a threshold, as for example, may be determined by the segmentation rules determination module 224 undergoing the fitness function assessment. The completion condition may also be any other metric that may be applied to the segmentation rule population, or the process of the genetic algorithm.

In some embodiments, the fitness function assessment performed by the segmentation rules determination module 224 may comprise applying the one or more segmentation rules associated with a present chromosome to a set of entities. The performance of the present chromosome may be assessed by comparing the outcome of applying the present chromosome's segmentation rule(s) to the set of entities, to a desired outcome as defined by the fitness function. This may be the number of entities that are classified into a specific segment that have a relatively medium survival rating (e.g. “1”) compared to the number of entities classified into the specific segment that have a relatively high survival rating (e.g. “0”), for example. In a further example, the present chromosome may be deemed to have satisfied the requirements of the fitness function if the ratio/percentage of entities assigned to the present chromosome that have a relatively high survival rating is less than a predetermined upper or lower limit, no more than 20% of the set of entities, for example. The fitness function assessment may be performed on each chromosome in the set of chromosomes one-by-one, or simultaneously.

In some embodiments, subsequent to the fitness function assessment, the segmentation rules determination module 224 may perform the splitting process on a set of high performing chromosomes. The set of high performing chromosomes may comprise one or more chromosome with a high fitness function assessment outcome value relative to the chromosome population. For example, the chromosomes within a top portion of the highest outcome values may be selected for the splitting process, such as the top 10 chromosome outcome values.

The segmentation rules determination module 224 may be configured to perform the splitting process by randomly choose a percentage along the chromosome to perform the split, at 20%, creating a first gene subset of 20% of the length of the high performing chromosome and a second gene subset of 80% of the length of the high performing chromosome, for example. The segmentation rules determination module 224 may be configured to split the chromosome on a logical operator such as AND or OR to avoid creating nonsensical logic statements.

The segmentation rules determination module 224 may perform the cross over process by combining a first or second gene subset from a first split chromosome with a first or second gene subset from a second split chromosome to create a new chromosome. The segmentation rules determination module 224 may repeat the splitting process on each chromosome from the set of high performing chromosomes to determine a new set of chromosomes.

The segmentation rules determination module 224 may then perform the mutation process on each chromosome from the new set of chromosomes to create a new epoch of chromosomes. In some embodiments, the segmentation rules determination module 224 may randomly choose one or more genes to alter. The mutation may be randomly altering/replacing an entire risk segment rule set, a single risk segment rule, or one or more elements of a logical statement such as an entity feature, a comparison operator, a value/percentage/Boolean or a logical operator such as AND or OR.

Subsequent to the completion of the mutation process, the segmentation rules determination module 224 may then repeat the fitness function assessment, splitting process, cross over process and mutation process until a completion condition is met. The completion condition may be a certain number of iterations, or once the assessment outcome value of a chromosome satisfies the requirement(s) of the fitness function, for example.

In some embodiments, each chromosome comprises a series of segmentation rules defining one segment and each gene comprises a single risk segment rule. There may be an equal amount of chromosomes defining each segment, or there may not be an equal amount of chromosomes defining each segment. In some embodiments, the segmentation rules determination module 224 will first apply the chromosome configured to categorise entities that represent an unacceptable level of risk to the second dataset, and then apply, sequentially, or in a step-wise fashion, the chromosomes configured to categorise entities that represent a lowest risk level to the chromosomes configured to categorise entities that represent a highest risk level. The segmentation rules determination module 224 will step through each of the chromosomes in the following order based on the segment the chromosome defines: entities that represent an unacceptable level of risk, entities of very low risk, entities of low risk, entities of medium risk and entities of high risk. The segmentation rules determination module 224 may use this order as any entity that would have an unacceptable level of risk will not belong to any other segment, so removing them reduces the computational overhead for the remainder of the process. The segmentation rules determination module 224 then works through the chromosomes in increasing risk, as any entity that would be included in a risk segment of lower risk than any subsequent risk segment would automatically qualify for all subsequent risk segments. For example, an entity eligible to be placed in the low risk segment would also be eligible for the moderate risk segment. Therefore, removing those entities progressively reduces computational overheads.

In some embodiments, the financial risk categorisation module 226, comprises computer code, which when executed, causes the segmentation rules determination server 217 to apply the optimised risk segment rules to classify or segment entities according to risk, such as financial risk. In some embodiments, the financial risk categorisation module 226 may be configured to categorise or classify, according to financial risk, the entities whose attributes were used to determine the optimised risk segment rules. In some embodiment, the financial risk categorisation module 226 may be configured to categorise or classify, according to financial risk, the entities that were considered to be high performing entities (for example, in business) at the end of the specific period or were moderately well performing entities (for example, were in business at the start of the specific period but out of business at the end of the specific period). The optimised risk segment rules may classify an entity as belonging to any one of a given number of risk segments. In some embodiments, the optimised risk segment rules may cause an entity to be classified as belonging to one of six segments; “too risky”, “very low risk”, “low risk”, “medium risk”, “higher risk” and “not assigned”. In some embodiments, the financial risk categorisation module 226 may return a stratified list of entities indicating their allocated risk segment. In other embodiments, financial risk categorisation module 226 may classify a single entity into a risk segment.

In some embodiments, the segmentation rules determination server 217 may be configured to provide the optimised segmentation rules to another computer system or computer device via network 215 for use by a financial risk categorisation module 226 deployed thereon for categorising or classifying entities according to financial risk.

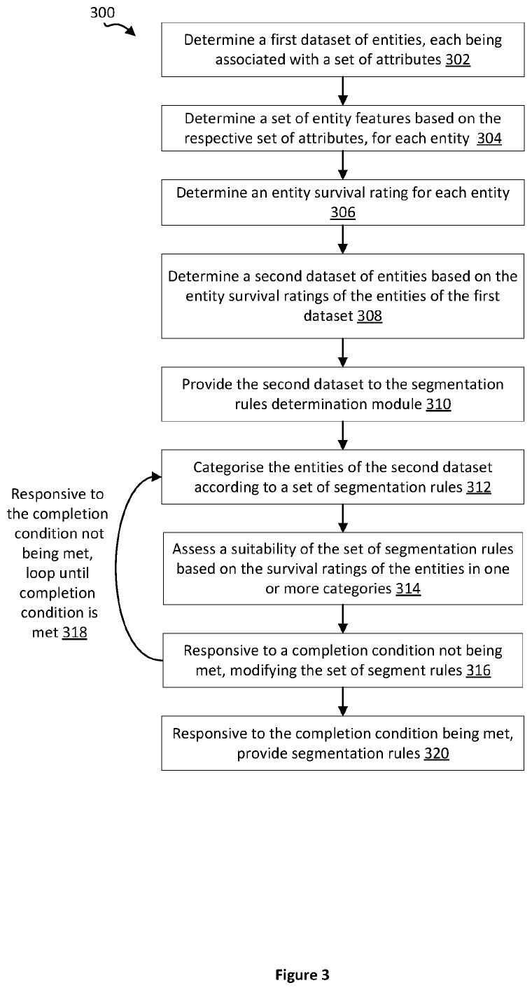

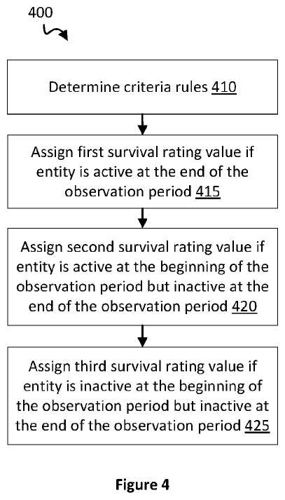

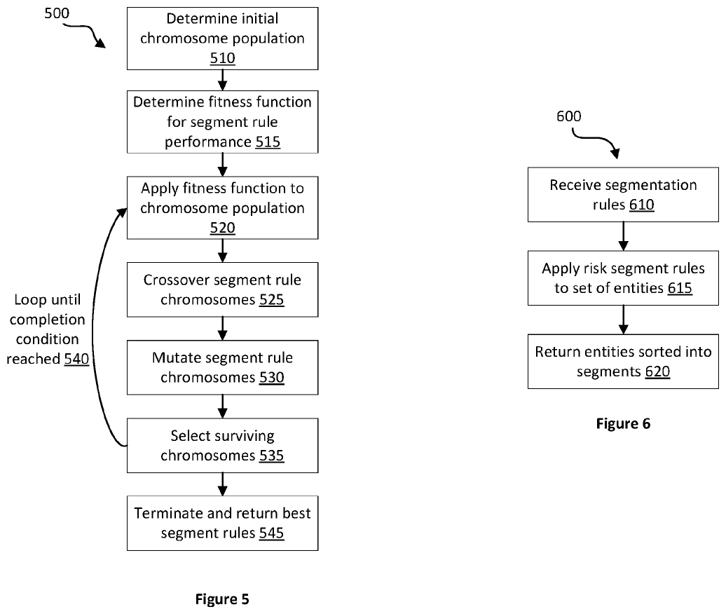

FIG. 3 is a process flow diagram of a method 300 for determining segmentation rules to categorise entities according to determined financial risk. The method 300 may be implemented by the system 200. In some embodiments, the segmentation rules determination server 217 may be configured to execute the modules stored in memory 219 to cause the segmentation rules determination server 217 to perform the method 300.

At 302, the segmentation rules determination server 217 determines a first dataset of entities, each entity of the first dataset being associated with a set of attributes. In some embodiments, the entity data determination module 220 determines the first dataset of entities, for example, from data determined from the database(s) 216, the accounting system 231, the client device(s) 210 and/or other third party sources. In some embodiments, the eligibility module 221 of the segmentation rules determination server 217 filters entity data to ensure that the first dataset of entities complies with eligibility factors. For example, eligibility factors may comprise compliance with relevant lending laws for financial services in a given jurisdiction, presence in a particular geographical location, use of a particular currency, etc.

At 304, the segmentation rules determination server 217 determines a set of features for each of the entities of the first dataset based on the respective set of attributes. Each feature may be indicative of financial risk. In some embodiments, entity features module 222 of the segmentation rules determination server 217 determines the sets of features. The segmentation rules determination server 217, or entity features module 222 may determine the sets of features.

At 306, the segmentation rules determination server 217 determines a survival or health rating for each of the entities of the first set of entities based on the respective set of attributes, and/or on the respective set of features. In some embodiments, the entity survival ratings module 223 of the segmentation rules determination server 217 determines the survival ratings. The segmentation rules determination server 217, or the entity survival ratings module 223 may determine the survival ratings according to method 400 described below, for example. The entity survival rating may be indicative of the predicted health of the business, and/or its predicted likelihood of survival, for example for a given period of time. The entity survival rating may be indicative of whether the business is in poor health and accordingly relatively high risk, medium health and accordingly relatively medium risk, or good health and accordingly relatively low risk. In some embodiments, the segmentation rules determination server 217 is configured to determine, based on an entity's respective set of attributes or features, if the entity is a high performing entity (for example, in business) at the end of a particular period of time, if the entity is a moderately well performing entity at the end of the particular period (for example, in business at the beginning of the particular period, but out of business at the end of the particular period), or if the entity is a low performing entity over the entirety of the particular period (for example, out of business at the beginning of the particular period). For example, the attributes or features considered may include number of dishonoured or unpaid invoices within a given period, a ratio of debits to credits over a particular period or periods of time, amount of debits and/or credits etc.

At 308, the segmentation rules determination server 217 determines a second set of entities from the first set of entities based on the predicted survival ratings of the entities. In some embodiments, the segmentation rules determination server 217 generates the second set of entities from the first set of entities by selecting, from the first set, only those entities that have survival ratings that comply with a survival rating criteria. In other words, the segmentation rules determination server 217 may eliminate or remove, from the first set, entities with survival ratings that do not comply with the survival rating criteria, to thereby create the second set of entities. For example, in the example described above, the second set of entities includes only those entities assign a survival rating of “0” (e.g., high performing entities (for example, entities determined as being still in business at the end of a particular period) or a survival rating of “1” (e.g., moderately well performing entities such as those determined as being in business at the start of the specific period but out of business by the end of the particular period).

At 310, the segmentation rules determination module 224 receives as inputs a survival rating and the set of entity features for each entity and determines a set of segmentation rules. The entity features of each entity are subjected to the set of segmentation rules to thereby categorise the entities into one of a plurality segments, and the survival ratings are used by the fitness function to determine the suitability or effectiveness of the set of segmentation rules In some embodiments, the segmentation rules determination module 224 is configured to optimise an initial set of rules according to a fitness function to thereby generate the set of segmentation rules. For example, the fitness function may be defined as the ratio/percentage of entities assigned to a specific segment that have a survival rating of “1” compared to the number of entities assigned to the specific segment that have a survival rating of “0”, or that the total number of entities that are assigned to a specific segment cannot be more than a predetermined proportion of the entire population of entities, while requiring the percentage of entities with a survival rating of “1” assigned to the segment is below an upper limit.

At 312, segmentation rules determination module 224 categorises the second set of entities into categories based on a set of segmentation rules.

In some embodiments, the segmentation rules may comprise a first rule set configured to categorise a relatively highest risk category of entities and a second rule set configured to categorise a relatively lowest risk category of entities. When categorising the second set of entities, the segmentation rules determination module 224 may apply the first rule set to the dataset of entities to categorise a first portion of the dataset, the first portion being associated with the entities of relative highest risk category. The segmentation determination rules module 224 will subsequently apply the second rule set to the uncategorised entities of the second set of entities, to categorise a second portion of the second set of entities as associated with a relative lowest risk category.

In some embodiments, the segmentation rules determination module 224 may comprise a third rule set, configured to categorise a relative medium risk category of the second set of entities. Subsequent to applying the second rule set to the uncategorised entities of the second set of entities, the segmentation rules determination module 224 may apply the third rule set to the uncategorised entities of the second set of entities to categorise a third portion of the second set of entities associated with the relative medium risk category.

At 314, the segmentation rules determination module 224 assesses the suitability of the set of segmentation, which is a first instance may be the initial rules, used to categorise the second set of entities. The segmentation rules determination module 224 may assess the suitability of the set of segmentation rules using the fitness function. In some embodiments, the segmentation rules determination module 224 may assess the segmentation rules by determining the number of entities categorised into one or more category, and calculating the number of entities in one of the one or more categories with a survival rating of “1”, relative to the number of entities in the category with a survival rating of “0”. In some embodiments, the fitness function will return a determination of whether or not a predefined completion condition has been met. In other embodiments, the determination may be an internally stored and updated variable stored in the segmentation rules determination module 224.

At 316, responsive to determining that the completion condition has not been met (for example, on receipt of an indication), the segmentation rules determination module 224 may modify the set of segmentation rules according to method 500 described below, for example.

At 318, subsequent to modifying the segmentation rules, the segmentation rules determination module 224 may cause the previous steps of categorisation 312 and suitability assessment 314 to be repeated on the newly modified segmentation rules.

At 320, responsive to determining that the completion condition being met, the segmentation rules determination server 217 provides, as an output of the segmentation rules determination module 224, the set of segment rules for categorising entities according to financial risk. For example, the determined set of segment rules for categorising entities according to financial risk may be provided to the financial risk categorisation module 226 for use in categorising or classifying entities according to financial risk, as described with reference to method 600 of FIG. 6 described below.

Entity survival ratings may be determined by entity survival module 223 for each of the entities of the first dataset of entities based on the respective set of attributes, and/or on the respective set of features, and compliance with a set of criteria or survival criteria.

The entity survival module 223 determines whether an entity is active at the end of the observation period, and responsive to determining that the entity is active at the end of the observation period, the entity survival module 223 assigns the entity a first survival rating value, at 415. If the entity is not determined to be active at the end of the observation period, the entity survival module 223 determines whether the entity is active at the beginning of the observation period, and responsive to determining that an entity is active at the beginning of the observation period but inactive at the end of the observation period, the entity survival module 223 assigns the entity a second survival rating value, at 420. If the entity is not determined to be active at the end of the observation period or at the beginning of the specific period, the entity survival module 223 assigns the entity a third survival rating value, at 425. The first, second and third survival rating values are different to one another.

In some embodiments, an entity's survival rating may indicate that they are in business at the end of the observation period, in business at the start of the observation period but out of business by the end of the observation period, or out of business at the beginning of the observation period. These survival ratings may be denoted by a 0, 1 or a −1 respectively.

In some embodiments, the segmentation rules determination server 217 may assess the accuracy or performance of the entity survival module 223, performing a quality or control measure, by comparing the rates of each calculated survival rating to control data taken from real world entities to determine a measure of reliability of the entity survival calculation process.

Segmentation rules determination module 224 may determine or receive the initial chromosome population for the genetic algorithm using the set of features and survival rating for each entity of the second dataset, at 510. In some embodiments, the set of initial segmentation rules of the initial chromosome population may be generated randomly. In some embodiments, the set of initial segmentation rules may be generated by reusing a set of previously generated segmentation rules. The set of initial segmentation rules may be comprised of a collection of entity features, equality operators, values/percentages and conditional operators organised into logic statements.

The fitness function for assessing the quality of the chromosomes may be determined by segmentation rules determination module 224, at 515. The fitness function may define a performance requirement of the chromosomes. Segmentation rules performance may be determined by the number of entities classified into each segment or one specific segment, and/or the overall acceptable risk while maximising profit for all segments or in one specific segment, for example.

Segmentation rules determination module 224 may perform the fitness function assessment using the fitness function to determine the performance of the initial chromosomes, at 520. The fitness function may be configured to give a performance score to the chromosome currently being assessed. Subsequently, segmentation rules determination module 224 will move on to the next chromosome and complete the same process. In some embodiments the fitness function assessment process may be done simultaneously for all chromosomes.

In some embodiments, the fitness function will define an acceptable performance of the chromosome to categorise a certain number of percentage of entities, into one or more segments. A set of chromosomes that are closest to the acceptable performance defined by the fitness function may be defined as a set of high performing chromosomes, the top 10, for example.

Segmentation rules determination module 224 may perform the splitting process by taking the set of high performing chromosomes and randomly selecting a subset of the high performing chromosome's genes. The segmentation rules determination module may then perform the cross over process, at 525. The segmentation rules determination module 224 may randomly select a subset of genes, splitting the chromosome only on logical operators such as AND or OR. Splitting chromosomes only on logical operators ensures that any subset of genes is a complete logic statement or set of logic statements. This may be done iteratively or to all chromosome subsets simultaneously.

Individual genes of each chromosome in the new epoch are then randomly mutated by segmentation rules determination module 224 in the mutation process, at 530. This mutation may be randomly altering and/or replacing an entire segment rule set, a single segment rule, or one or more elements of a logical statement such as an entity feature, a comparison operator, a value/percentage/Boolean or a logical operator such as AND or OR. Segmentation rules determination module 224 returns the new epoch, at 535. Segmentation rules determination module 224 then iterates the fitness function assessment, cross over process and mutation process until a completion condition is met, at 540. The completion condition may be a certain number of iterations, and/or a particular level of performance of the chromosomes as defined by the fitness function. Once the completion condition has been fulfilled, the segmentation rules determination module 224 returns or outputs the determined segmentation rules, at 545.

FIG. 6 is a process flow diagram of a method 600 for applying the determined risk segmentation rules to one or more candidate entities. In some embodiments, after the segmentation rules have been determined by the segmentation rules determination module 224, the financial risk categorisation module 226 may receive the segmentation rules, at 610.

The financial risk categorisation module 226 may apply the segmentation rules to each entity's features and assign each entity to the corresponding segment, at 615. In some embodiments the entities may be separated in any number of segments. In some embodiments, the financial risk categorisation module 226 may be configured to categorise or separate the entities into six segments, such as categories: “too risky”, “very low risk”, “low risk”, “medium risk”, “higher risk” and “not assigned”. The financial risk categorisation module 226 may then return a stratified list of entities indicating their allocated segment, at 620. In other embodiments, the financial risk categorisation module 226 may categorise one entity into a segment, at 620.

In other embodiments, the segmentation rules determination server 217 may provide to a client device 210 or server (not shown), separate to system 200, the determined segmentation rules. The segmentation rules may be transferred via the network 215, a wired network (not shown) and/or portable data storage device. Subsequent to determining or receiving the segmentation rules at 610, the client device 210 or server (not shown) may apply the segmentation rules to a set of entities at 615. The client device 210 or server (not shown) may then return a stratified list of entities, organised into segments by the segmentation rules, at 620.

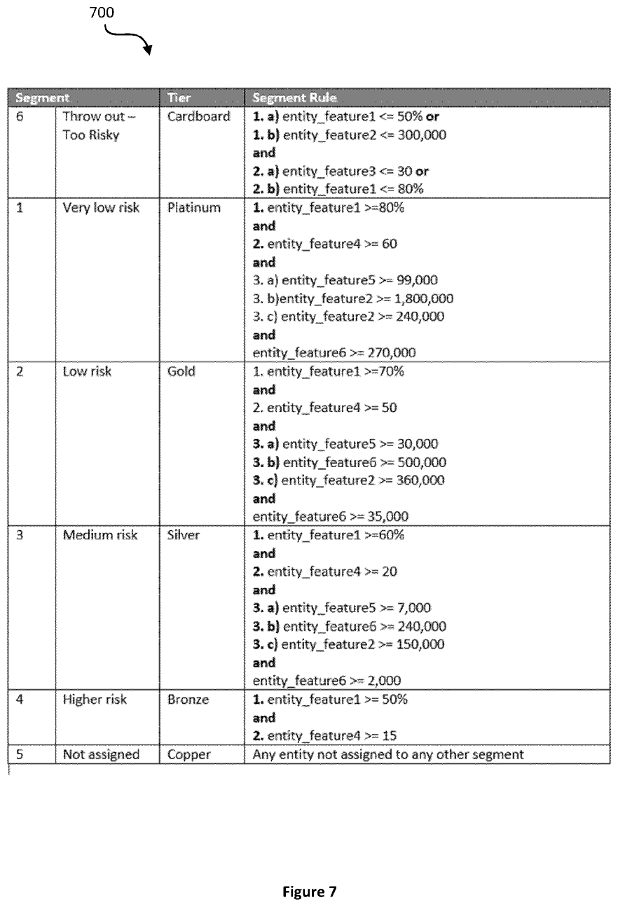

FIG. 7 is a table containing an example of segmentation rule set 700, according to some embodiments. Each segment rule set comprises at least one segment rule, which, when applied to an entity, based on the entity features associated with that entity, will classify the entity into, or exclude them from, a financial risk segment or category. In some embodiments, each segment may have a unique set of combinations of entity features, comparison operators, values/percentages and logical operators such as AND or OR. In other embodiments, different segments may have some or all entity features in common but the logic statements may comprise different values/percentages/Booleans or comparison operators. Each segment may have a unique level of risk associated with it; this risk may be denoted by a term such as too risky, very low risk, low risk, medium risk or high risk. This level of risk may be denoted by a percentage chance of the entities contained within the segment going out of business during, or after the specific period (not shown).

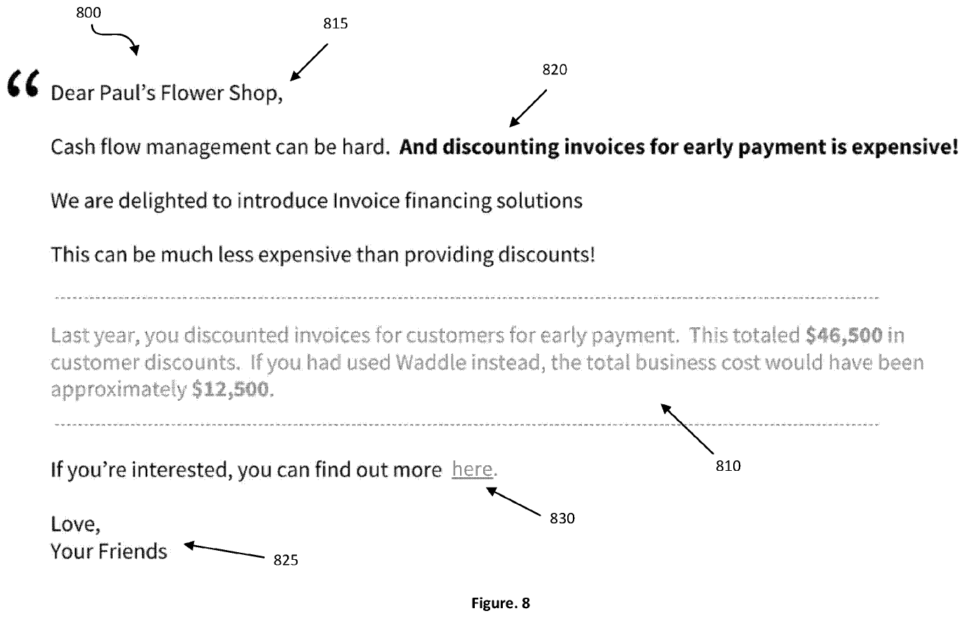

Exemplified in FIG. 8 is message communication 800 between a financial services provider and an entity 815. In some embodiments, an entity that has been categorised or classified in a risk category or segment using the method 600 of FIG. 6 may receive message 800 at its client device 210, from a server (not shown) of the financial services provider, or via the accounting system 231, for example, offering the entity the opportunity to receive financial assistance products (or loans). In some embodiments, these financial assistance products may be invoice financing. The entity 815 may receive message 800 that makes them aware of potential invoice financing services made available to them. Message 800 may comprise body text 820 that explains the offer of invoice financing. The message 800 may also comprise financial analysis text 810. The financial analysis text 810 may comprise financial data related to the entity's 815 invoice discounting, or invoice cancelling behaviours and the amount of money this has cost entity 815. Financial analysis text 810 may also comprise the amount of money the entity 815 may have spent receiving invoice financing. Entity 815 may respond to message 800 by clicking link 830, responding to message 800 via the message platform they received message 800 on, such as an email client, or contacting financial services provider 825 through any other channels available to them.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

What is claimed is:

1. A computer implemented method comprising:
a) determining a first dataset of entities, each entity of the first dataset of entities being associated with a set of attributes;
b) determining a set of features for each of the entities based on a respective set of attributes, wherein each feature is indicative of financial risk;
c) determining a survival rating for each of the entities of the first dataset of entities based on the respective set of attributes;
d) determining a second set of entities from the first dataset of entities based on predicted survival ratings of the entities;
e) providing, as an input to a segmentation rules determination module, the set of features and the survival rating for each of the entities of the second set of entities;
f) categorising, by a segmentation rules determination module, the entities of the second set of entities according to a set of segmentation rules;
g) assessing a suitability of the set of segmentation rules based on survival ratings of the entities in one or more categories;
h) responsive to a completion condition not being met, modifying, by the segmentation rules determination module, the set of segment rules and performing steps f) to h); and
i) responsive to the completion condition being met, determining as an output of the segmentation rules determination module, the set of segment rules for categorising entities according to financial risk.

2. The method of claim 1, comprising:
providing to a financial risk categorisation module, the determined set of segment rules, the financial risk categorisation module configured to use the determined set of segmentation rules to classify candidate entities according to financial risk.

3. The method of claim 2, comprising:
providing a set of features of a candidate entity and a predicted survival rating of the candidate entity to the financial risk categorisation module; and
classifying, by the financial risk categorisation module, the financial risk of the candidate entity.

4. The method of claim 2, comprising:
providing the set of features and respective survival rating of each of the entities of a second dataset to the financial risk categorisation module; and
classifying, by the financial risk categorisation module, the financial risk of the entities of the second dataset.

5. The method of claim 1, wherein determining the first dataset of entities comprises:
determining entities from a population of entities that comply with one or more eligibility factors.

6. The method of claim 1, wherein the set of segmentation rules comprising a first rule set configured to categorise a relatively highest risk category of entities and a second rule set configured to categorise a relatively lowest risk category of entities, and wherein categorising, by a segmentation rules determination module, the entities of the second set of entities according to the set of segmentation rules comprising applying the first rule set to the second set of entities to categorise a first portion of the second set of entities as associated with the relatively highest risk category, and subsequently applying the second rule set to uncategorised entities of the second set of entities, to categorise a second portion of the second set of entities as associated with the relatively lowest risk category.

7. The method of claim 6, wherein the set of segmentation rules comprises a third rule set configured to categorise a relatively medium risk category of entities and wherein categorising, by a segmentation rules determination module, the entities of the second set of entities according to the set of segmentation rules comprising subsequent to applying the applying the second rule set to the uncategorised entities of the second set of entities, applying the third rule set to the uncategorised entities of the second set of entities, to categorise a third portion of the second set of entities as associated with the relatively medium risk category.

8. The method of claim 1, wherein determining the survival rating for each of the entities of the first dataset of entities based on the respective set of attributes comprises:
determining whether an entity is active at an end of an observation period;
responsive to determining that the entity is active at the end of the observation period, assigning the entity a first survival rating value;
responsive to determining that the entity is inactive at the end of the observation period, determining whether the entity is active at the observation period;
responsive to determining that the entity is active at the beginning of the observation period, assigning the entity a second survival rating value; and
responsive to determining that the entity is inactive at the beginning of the observation period, assigning the entity a third survival rating value;
wherein the first survival rating value, the second survival rating value and the third survival rating value are different to one another.

9. The method of claim 1, wherein determining a second dataset of entities from the first dataset of entities based on the determined survival ratings of the entities comprises:
removing from the first dataset of entities, any entities that have a survival rating indicating they were low performing entities.

10. The method of claim 1, wherein the segmentation rules determination module comprises a genetic algorithm.

11. The method of claim 10, wherein the genetic algorithm is configured to optimise a set of initial segmentation rules according to a fitness function.

12. A system comprising:
one or more processors; and
memory comprising computer executable instructions, which when executed by the one or more processors, cause the system to perform operations including:
a) determining a first dataset of entities, each entity of the first dataset of entities being associated with a set of attributes;
b) determining a set of features for each of the entities based on a respective set of attributes, wherein each feature is indicative of financial risk;
c) determining a survival rating for each of the entities of the first dataset of entities based on the respective set of attributes;
d) determining a second set of entities from the first dataset of entities based on predicted survival ratings of the entities;
e) providing, as an input to a segmentation rules determination module, the set of features and the survival rating for each of the entities of the second set of entities;
f) categorising, by a segmentation rules determination module, the entities of the second set of entities according to a set of segmentation rules;
g) assessing a suitability of the set of segmentation rules based on survival ratings of the entities in one or more categories;
h) responsive to a completion condition not being met, modifying, by the segmentation rules determination module, the set of segment rules and performing steps f) to h); and
i) responsive to the completion condition being met, determining as an output of the segmentation rules determination module, the set of segment rules for categorising entities according to financial risk.

13. A computer-readable storage medium storing instructions that, when executed by a computer, cause the computer to perform operations including:
a) determining a first dataset of entities, each entity of the first dataset of entities being associated with a set of attributes;
b) determining a set of features for each of the entities based on a respective set of attributes, wherein each feature is indicative of financial risk;
c) determining a survival rating for each of the entities of the first dataset of entities based on the respective set of attributes;
d) determining a second set of entities from the first dataset of entities based on predicted survival ratings of the entities;
e) providing, as an input to a segmentation rules determination module, the set of features and the survival rating for each of the entities of the second set of entities;
f) categorising, by a segmentation rules determination module, the entities of the second set of entities according to a set of segmentation rules;
g) assessing a suitability of the set of segmentation rules based on survival ratings of the entities in one or more categories;
h) responsive to a completion condition not being met, modifying, by the segmentation rules determination module, the set of segment rules and performing steps f) to h); and
i) responsive to the completion condition being met, determining as an output of the segmentation rules determination module, the set of segment rules for categorising entities according to financial risk.
